(19) United States
(12) Patent Application Publication
(10) Pub. No.: US 2015/0217663 A1
(43) Pub. Date: Aug. 6, 2015

(54) MOTORCYCLE PASSENGER ARM REST

(71) Applicant: Kuryakyn Holdings, LLC, Somerset, WI (US)

(72) Inventor: Daniel E. PARVEY, New Richmond, WI (US)

(73) Assignee: Kuryakyn Holdings, LLC, Somerset, WI (US)

(21) Appl. No.: 14/169,377

(22) Filed: Jan. 31, 2014

(51) Int. Cl. B60N 2/46; B62J 1/28

(52) U.S. Cl. CPC B60N 2/46; B62J 1/28

(57) ABSTRACT

A motorcycle passenger arm rest assembly includes a pair of mounting brackets that are mounted on a front surface of a motorcycle trunk lid, near each side of the lid. A support arm is connected to each bracket. The support arm carries an arm rest, to support the arm rests at a position suitable to support the arms of a motorcycle passenger. The support arms are configured to allow the arm rests to pivot from a first extended position, to provide support for a passenger's arms, to a second retracted position, to enable a passenger to easily mount and dismount from the passenger seating area.

### BACKGROUND

Touring motorcycles provide seating for a passenger behind the motorcycle operator. There continues to be a need for passenger arm rests that are positioned to support the arms of a motorcycle passenger while the motorcycle is being operated, but does not inhibit passenger mounting and dismounting from the motorcycle.

### SUMMARY

### Brief Description of the Drawings

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a partial side view of a passenger seating area of a motorcycle equipped with one embodiment of the passenger arm rest of the present invention.

FIG. 2 is a perspective view of a motorcycle trunk lid with the arm rest assembly of FIG. 1 secured to a front outer surface of the lid.

FIG. 3 is a perspective view of one embodiment of a mounting bracket for mounting the arm rest assembly to the trunk lid.

FIG. 4 is a perspective view of a bracket assembly for securing the mounting bracket of FIG. 3 to the trunk lid and for linking the arm rest assembly to the passenger backrest.

FIG. 5 is a rear perspective view of the inner surface of the trunk lid showing a mounting plate for securing the mounting bracket of FIG. 3 to the lid.

FIG. 6A is a first side perspective view of a mounting arm for mounting the arm rest to the mounting bracket.

FIG. 6B is a second side perspective view of a mounting arm for mounting the arm rest to the mounting bracket.

FIG. 7A is a side perspective view of one embodiment of an arm rest support frame.

FIG. 7B is a side perspective view of an arm rest covering the arm rest support frame of FIG. 7A.

### DETAILED DESCRIPTION

In the following Detailed Description, reference is made to the accompanying drawings, which form a part hereof, and in which is shown by way of illustration exemplary embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments or variations may be utilized and structural or logical changes may be made without departing from the scope of the present invention. The following detailed description, therefore, is not to be taken or construed in a limiting sense, and the scope of the present invention is defined solely by the appended claims. The terms used in the claims are intended to have their plain, ordinary meaning and no disclosure or written description herein shall be construed to specially or uniquely define the claim terms unless it is explicitly stated herein that such term is being given a specific definition.

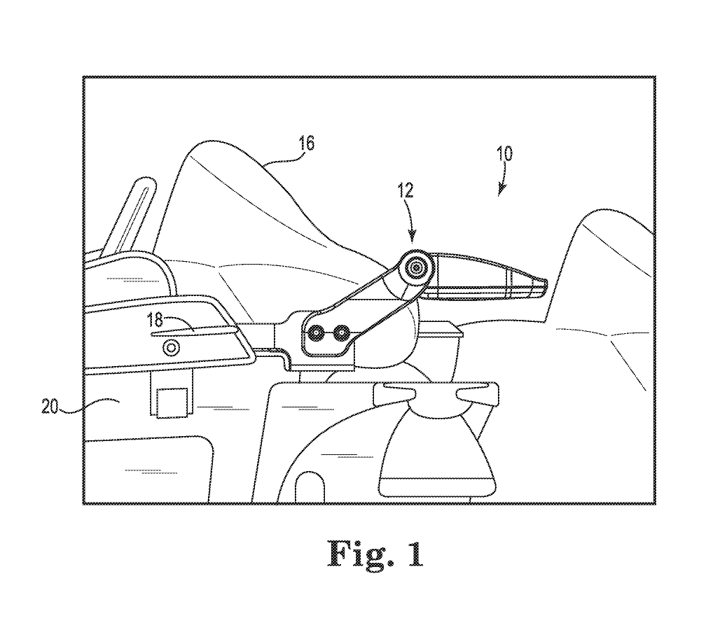

FIG. 1 is a partial side view of a passenger seating area of a motorcycle equipped with one embodiment of the passenger arm rest 10 of the present invention. As illustrated, the passenger arm rest 10 is comprised of a pair of arm rest assemblies 12 and 14 mounted on either side of the motorcycle adjacent to a cushioned passenger back rest 16. As is common for touring motorcycles, the passenger backrest 16 may be mounted in part to a front portion of a lid 18 of a motorcycle trunk 20 carried at the rear end of the motorcycle.

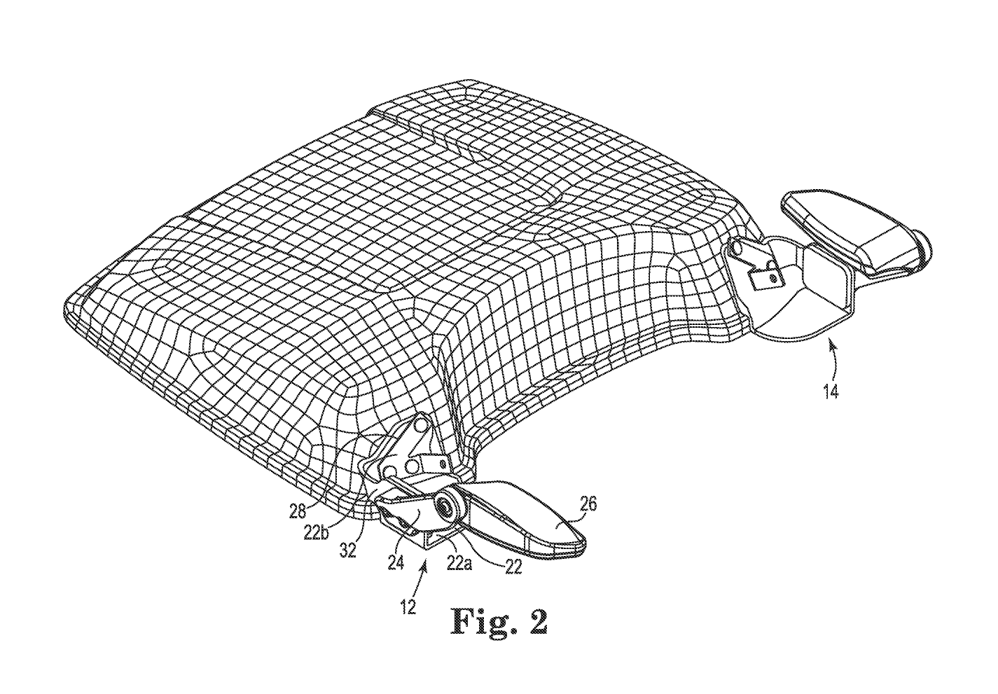

FIG. 2 is a front perspective view of the motorcycle trunk lid 18 with the arm rest assemblies 12 and 14 secured to a front outer surface of the lid 18 at opposite sides of lid 18. For ease of description, the passenger backrest, which is located between arm rest assemblies 12 and 14, is not shown. Each arm rest assembly 12 and 14 is identical to one another, with the exception that assembly 12 is a mirror image to assembly 14. For ease of description, the subsequent description of the arm rest assemblies will be made by reference to arm rest assembly 12. In one embodiment, arm rest assembly 12 is comprised of a mounting bracket 22, an arm rest support arm 24, and an arm rest 26. Each mounting bracket 22 includes a first bracket portion 22a, and a second bracket portion 22b. The first bracket portion 22a includes a rear portion 28, which is shaped to match a front surface and lip of lid 18. The first bracket portion 22a further includes a forward projecting bottom and side portion 30 and 32, respectively. In one embodiment, the rear portion, bottom portion and side portion of mounting bracket 22 are integrally formed from stamped metal. In an alternative embodiment, the rear, bottom and side portions may be separate components that are connected to one another in a suitable manner, such as welding.

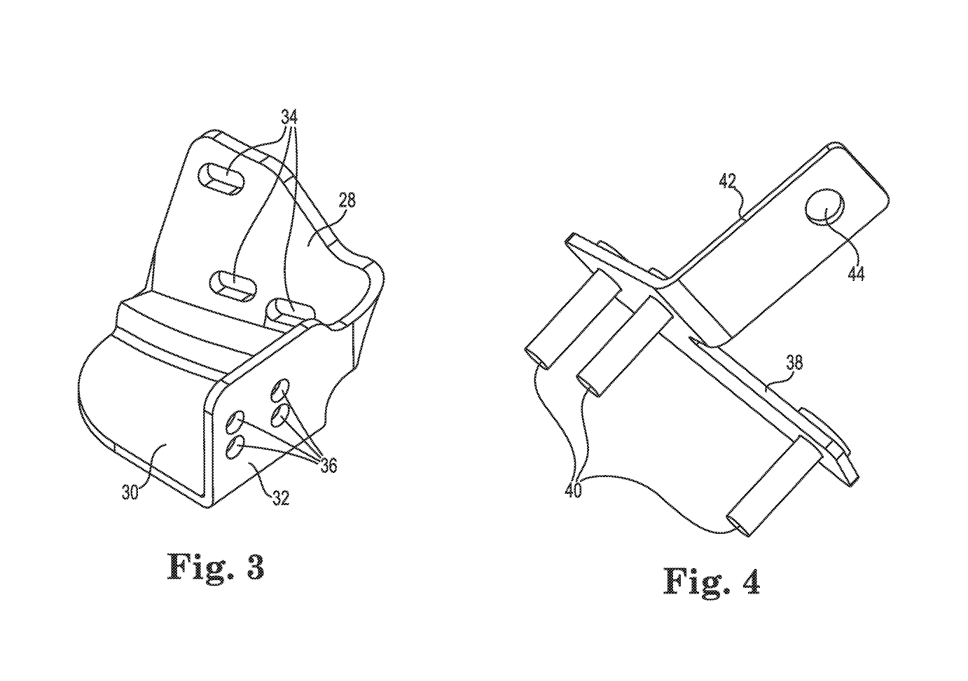

As shown in FIG. 3, which is a perspective view of the first bracket portion 22a of mounting bracket 22, the rear portion 28 is configured with a plurality of openings 34, which allow mounting bracket 22 to be secured to lid 18 with connectors (not shown). In one embodiment, each opening 34 is elongate, to permit adjustments in the location of mounting bracket relative to corresponding mounting holes in lid 18. As further shown in FIG. 3, the side portion 32 is configured with a plurality of openings 36, which enable mounting of the arm rest support arm 24 relative to mounting bracket 22 with appropriate connectors. In one embodiment, openings 36 are arranged as a pair of lower openings and a pair of upper openings. The arm rest support arm 24 may be secured to one or the other pair of openings 36, which provides a vertical adjustment of the arm rest 26 carried on the arm rest support arm 24.

FIG. 4 is a perspective view of the second bracket portion 22b of mounting bracket 22. The second bracket portion 22b is comprised of a metal base 38 configured to secure a plurality of connectors 40 to correspond with the plurality of openings 34 in the first bracket portion. The second bracket portion thus is positioned with the plurality of connectors 40 in the plurality of openings 34. Connectors 40 have a length sufficient to pass through the rear portion 28 and extend through corresponding mounting holes in lid 18 to thereby allow mounting bracket 22 to be secured to lid 18. The second bracket portion 22b is further provided with a tab 42 that is secured to base 38 and extends at an angle relative thereto. Tab 42 is provided with a mounting hole 44. Tab 42 allows mounting bracket 22 to be secured in part to a portion of the passenger back rest with an appropriate connector, such as a threaded nut and bolt.

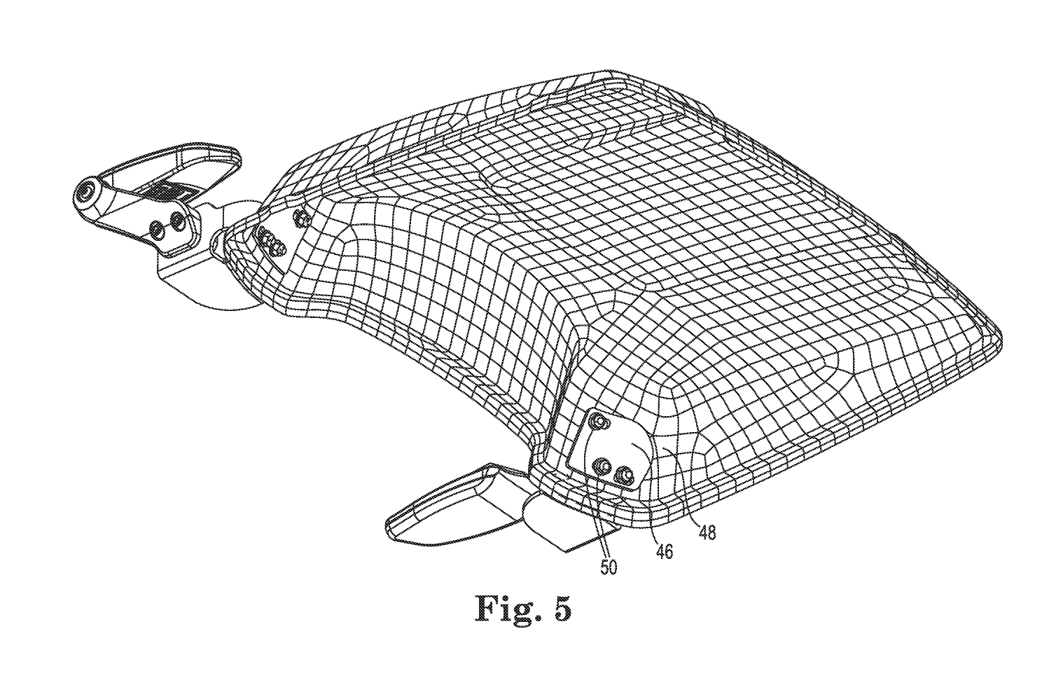

As shown in FIG. 5, with the second bracket portion 22a of mounting bracket 22 positioned against the front outer surface of lid 18, near one side of lid 18, the first bracket portion 22b and its connectors 40 pass through corresponding mounting holes in lid 18. A metal plate 46 configured with openings that correspond with connectors 40, is positioned against the inner surface 48 of lid 18 with an end portion of connectors 40 exposed after passing through the openings of plate 46. Corresponding connectors, such as threaded nuts 50, are then secured to connectors 40 to secure mounting bracket 22 to lid 18.

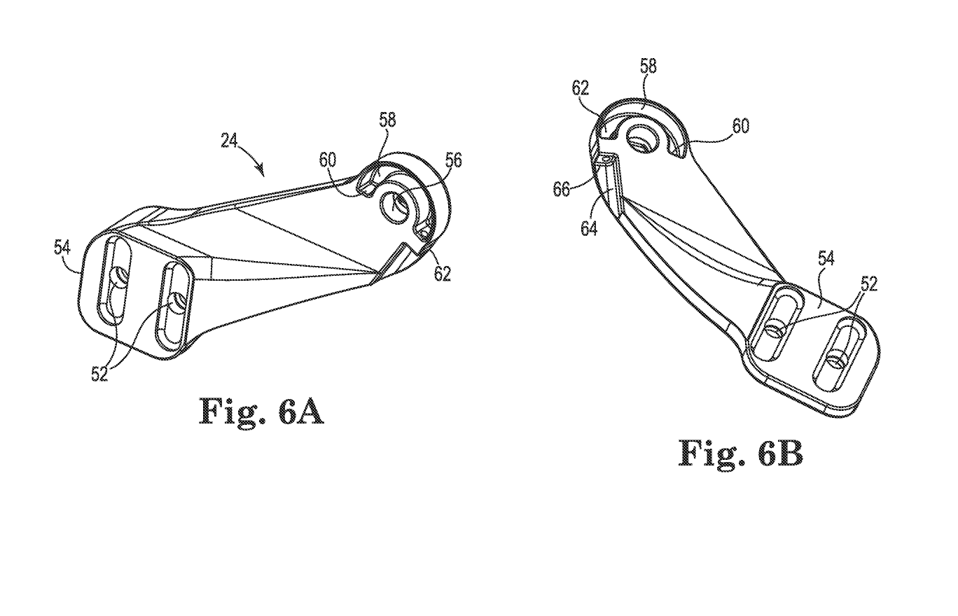

FIG. 6A is a perspective view of one embodiment of the arm rest support arm 24 which mounts to the side portion 32 of mounting bracket 22. As shown in FIG. 6A, the inner surface of support arm 24, which faces the side portion 32, is provided at one end with a pair of mounting holes 52 that extend through the lower portion 54 of support arm 24. Mounting holes 52 correspond to either the upper or lower pair of holes 36 in side portion 32, according to the desired position of arm rests 26, to allow support arm 24 to be secured to mounting bracket 22 such as by threaded connectors, e.g., nuts and bolts. The opposite end of support arm 24 is provided with a central bore 56 and an arcuate slot 58 that is generally coaxially located around the central bore 56. According to the one embodiment shown, the arcuate slot 58 travels about 180 degrees around the bore 56. The arcuate slot defines ends 60 and 62, which function as stops to limit a range of travel of the arm rest (not shown). As shown in FIG. 6B, the support arm 24 is configured with a channel 64 below end 62 to provide access to a threaded bore 66 that extends to end 62. The threaded bore 66 receives a threaded adjustment screw (not shown) that permits variation of the stop point for the arm rest 26.

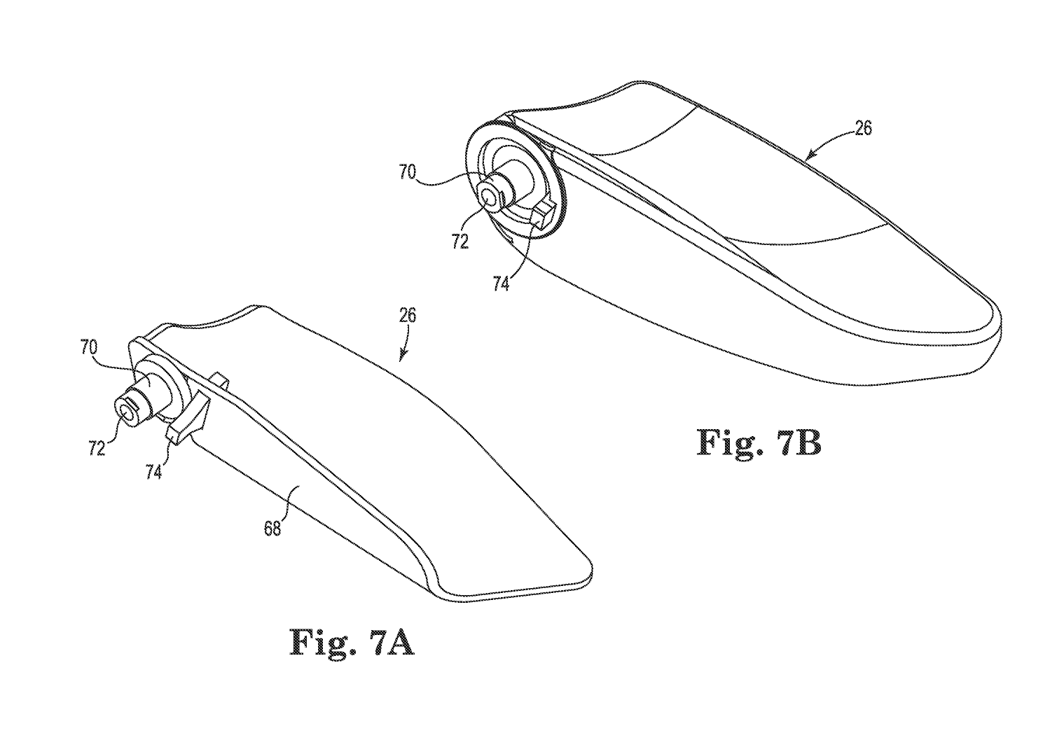

As shown in FIGS. 7A and 7B, the arm rest 26 comprises a support frame 68 which is covered by a cushioning material that is surrounded with a covering material in a standard manner known in the art, such as by over-molding. Frame 68 may be made from any suitable support material, such as metal. The frame 68 is provided with a mounting stud 70 that is configured with a central bore 72. Adjacent to the stud 70, the frame 68 is also provided with a post 74. When arm rest 26 is mounted to the support arm 24, the stud 70 extends through the central bore 56 and the post 74 is located within the arcuate slot 58. A connector, such as a threaded bolt, connects to the central bore 72 of stud 70 to secure arm rest 26 to the support arm 24. So connected, arm rest 26 is able to pivot through a range of travel defined by the arcuate slot 58, with the post 74 serving to support the arm rest against ends 60 and 62. As previously disclosed the location of post 74, and hence the position of arm rest 26, can be varied relative to end 62 by virtue of the position of the adjustment screw that can be located in the threaded bore 66. As shown in FIG. 2, arm rest 26 on arm rest assembly 12 is shown in a first, extended position with the post 74 at or near end 62 of the arcuate slot, for use by a motorcycle passenger. Arm rest 26 is able to pivot 180 degrees, as shown on arm rest assembly 14, when the arm rest 26 is not in use, such as to permit easy access for a motorcycle passenger to the passenger seat area.

It is to be understood that the features of the various exemplary embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An arm rest for a passenger of a motorcycle equipped with a motorcycle trunk, comprising:
a bracket mountable to a lid of the motorcycle trunk;
a support arm having a first end and a second end, the first end connected to the bracket, the second end positioned at a level above bracket, adjacent to a motorcycle passenger seat; and
an arm rest pivotably connected to the second end of the support arm, the arm rest pivotable between a first extended position, and a second retracted position.
